(19) United States
(12) Patent Application Publication
(10) Pub. No.: US 2008/0252664 A1
(43) Pub. Date: Oct. 16, 2008

(54) Device and Method for Driving Light-Emitting Diodes

(76) Inventors: Zhi-Xian Huang, Hsinchu (TW); Kun-Chieh Chang, Hsinchu (TW); Chieh Yang Chun, Hsinchu (TW); Hong-Xi Cao, Hsinchu (TW)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/779,135

(22) Filed: Jul. 17, 2007

Related U.S. Application Data
(60) Provisional application No. 60/907,616, filed on Apr. 11, 2007.

(51) Int. Cl. G09G 5/10; G09G 3/36

(52) U.S. Cl. 345/690; 345/102

(57) ABSTRACT

A light-emitting diode (LED) driver is provided to drive an LED. The LED driver includes a clock supply to periodically output a modulation period. A brightness controller is provided to receive brightness data corresponding to the desired brightness of the LED. The brightness controller generates a pulse-width-modulated (PWM) duty pulse within the modulation period, a width of the PWM duty pulse being based on the brightness data. The LED driver also includes a detection controller to receive detection data indicating whether the LED is to be detected during the modulation period. When the detection data indicate that the LED is to be detected during the modulation period, the detection controller generates a detection pulse within the modulation period. A driver output is provided to output the PWM duty pulse and the detection pulse to the LED within the modulation period.

### RELATED APPLICATION

The present application claims the benefit of priority of U.S. Provisional Application No. 60/907,616, filed Apr. 11, 2007, entitled “Flicker Free LED Light intensity Detection.” This provisional application is expressly incorporated herein by reference in its entirety.

### TECHNICAL FIELD

This invention generally relates to driving light-emitting diodes.

### BACKGROUND

Certain types of displays, such as liquid crystal displays (LCDs), may have a controllably transmissive display panel that faces a viewer and a backlight to illuminate the display panel from behind. The backlight may be a light-emitting diode (LED) backlight, a cold cathode fluorescent lamp (CCFL), or a hot cathode fluorescent lamp (HCFL). The display panel may have an array of controllably transmissive pixel elements. Each pixel element of the display panel may be electrically coupled to an element driver that controls the pixel element to selectively block or transmit light emanating from the blacklight. For example, each pixel element of an LCD display may include a liquid crystal color filter (such as for a color display) or liquid crystal light blocker (such as for a monochrome display).

The LED backlight may have an array of LEDs arranged to illuminate the array of pixel elements. The individual LEDs of the array may be arranged in groups. Each group of LEDs may have at least one LED that produces each of a set of colors. An LED backlight that emits “white” light may have a plurality of groups of LEDs, and each group of LEDs may have a red LED, a green LED, and a blue LED. The red light produced by the red LED, the green light produced by the green LED, and blue light produced by the blue LED may combine to produce an approximately white light.

LED backlights may have certain advantages over other backlight designs, such as CCFLs and HCFLs. For example, accurate color reproduction by the display may require a complete set of colors from the backlight. Fluorescent lamps, however, may not emit a sufficient amount of light at certain frequencies of light that correspond to transmission colors of the pixel elements. This may cause displayed images to appear dull or have inaccurate color expression. Fluorescent lamps also typically contain mercury, which is poisonous to living organisms including humans. Mercury may be released as a consequence of the manufacture or disposal of fluorescent lamps, resulting in hazardous environmental pollution. In addition, LED backlights may have longer lifespans, smaller sizes, faster startup times, and/or more robustness to pressure and vibration than CCFLs. LED backlights may also be able to operate at lower input voltages than CCFLs while producing an equivalent brightness of light. Thus, LED backlights may be preferable over other backlights for some applications.

Unfortunately, the spectrum of light emitted from an LED backlight may deteriorate as a function of time and temperature. For example, the brightness of the LEDs of the LED backlight may decrease over time, causing the LED backlight to dim. In addition, the emission spectrum may dim unevenly as a function of frequency. This may result in displayed images that are dulled or have decreased accuracy of color expression.

### SUMMARY

An exemplary LED driver consistent with the present invention is provided to drive an LED. The LED driver comprises a clock supply to periodically output a modulation period. The LED driver further comprises a brightness controller to receive brightness data corresponding to the desired brightness of the LED, and generate a pulse-width modulated (PWM) duty pulse within the modulation period, a width of the PWM duty pulse being based on the brightness data. In addition, the LED driver comprises a detection controller to receive detection data indicating whether the LED is to be detected during the modulation period, and, when the detection data indicate that the LED is to be detected during the modulation period, generate a detection pulse within the modulation period. The LED driver also comprises a driver output to output the PWM duty pulse and the detection pulse to the LED within the modulation period.

An exemplary method consistent with the present invention is provided of driving an LED. The method comprises periodically outputting a modulation period. Brightness data is received that corresponds to the desired brightness of the LED. The method further comprises generating a pulse-width-modulated (PWM) duty pulse within the modulation periods a width of the PWM duty pulse being based on the brightness data. Detection data is received that indicates whether the LED is to be detected during the modulation period. The method additionally comprises, when the detection data indicate that the LED is to be detected during the modulation period, generating a detection pulse within the modulation period The method also comprises outputting the PWM duty pulse and the detection pulse to the LED within the modulation period.

### BRIEF DESCRIPTION OF THE DRAWINGS

The accompanying drawings, which are incorporated in and constitute a part of this specification, illustrate embodiments consistent with the invention and, together with the description, serve to explain advantages and principles of the invention In the drawings:

FIG. 1 is a block diagram of an exemplary embodiment of an LED driver, a group of LEDs, a detector, output signals from the detector, and a processor;

FIG. 2 is a graph showing a plurality of plots, the plots representing the light output of a green LED, a red LED, and a blue LED, respectively, as a function of time;

FIG. 3 is a graph showing a plurality of plots, the plots representing the light output of a red LED, a green LED, and a blue LED, respectively, as a function of temperature;

FIG. 4 is a graph showing an exemplary embodiment, consistent with the present invention, of a plurality of plots, each plot representing a signal applied to an LED; and

FIG. 5 is a graph showing an exemplary embodiment, consistent with the present invention, of a plurality of plots, each plot representing a signal applied to an LED.

### DESCRIPTION OF THE EMBODIMENTS

Reference will now be made in detail to exemplary embodiments consistent with the invention, examples of which are illustrated in the accompanying drawings. Wherever possible, the same reference numbers will be used throughout the drawings to refer to the same or like parts.

Light-emitting diodes (LEDs) may be implemented in an array to generate a controllable field of electromagnetic radiation (“light”) for various applications. The LEDs may include inorganic LEDs or organic LEDs (OLEDs). The array of LEDs may include a plurality of substantially similar groups of individual LEDs. For example, each of the groups may be adapted to generate light having a particular color, such as approximately white. In an exemplary embodiment, each group of LEDs includes a red LED, a green LED, and a blue LED. An array of these groups may be referred to as a “tricolor LED light source.” When all of the LEDs in one of these groups are turned on, that turned-on group may generate an approximately white light as a result of the combination of the red, green, and blue lights. Alternatively, the LEDs may not be arranged into substantially similar groups. For example, the LED backlight may include a plurality of “white” LEDs (such as, for example, InGaN—GaN LEDs). Each white LED generates an approximately white light.

In an exemplary embodiment, an LED backlight may implement an array of LEDs to illuminate a controllably transmissive panel. For example, a liquid-crystal display (LCD) panel may be illuminated from behind by the LED backlight to display a controllable image. The LCD panel may have a grid of elements to which voltages can be applied to selectively transmit one or more frequencies of the light emanating from the LED backlight. When an element is switched to an “on” state, the element may substantially transmit light emanating from the backlight, displaying a bright dot at the location of the element. When the element is switched to an “off” state, the element may substantially block light emanating from the backlight, displaying a dark dot at the location of the element.

A color LCD display may incorporate a white LED backlight. The LCD panel of the color LCD display may be controllable to display images according to a grid of pixels, where each pixel corresponds to three controllable LCD elements. The three controllable elements for each pixel may be a red LCD element, a green LCD element, and blue LCD element. These controllable color elements may be adapted to controllably transmit red light, green light, and blue light, respectively.

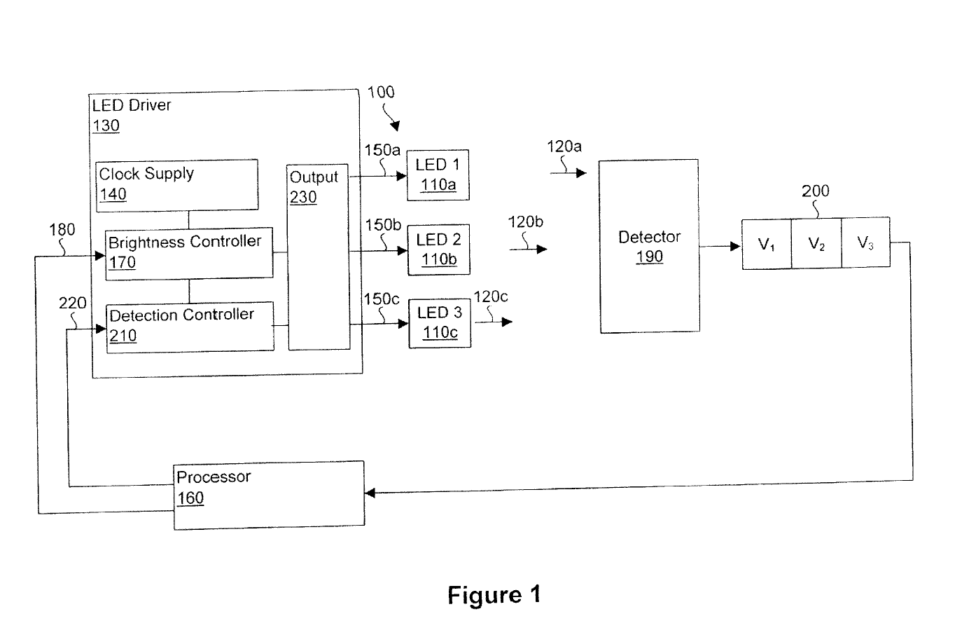

FIG. 1 is a block diagram of an exemplary embodiment of a group 100 of LEDs 110a-110c emitting a red light 120a, a green light 120b, and a blue light 120c, respectively. For example, group 100 could constitute one of a plurality of substantially similar groups of LEDs that are arranged in an array for a white LED backlight. Group 100 of LEDs 110a-110c of FIG. 1 is provided only to illustrate embodiments consistent with the invention, and should not be used to limit the scope of the invention or its equivalents to the exemplary embodiments provided he rein. For example, group 100 may include LEDs that emit light at colors different than, or in addition to, red, green, and blue. Group 100 may also include multiple LEDs of substantially the same color.

An LED driver 130 may be provided to drive LEDs 110a-110c LED driver 130 may include a clock supply 140 to periodically output a modulation period For example, clock supply 140 may generate the modulation period based on a clock signal from an internal or external clock (not shown), or clock supply 140 may transmit the clock signal itself as the modulation period. LED driver 130 may apply signals 150a-150c to LEDs 110a-110c to turn on or off the LEDs during each of the modulation periods. For example, each of signals 150a-150c may be individually generated to individually turn on or turn off each of LEDs 110a-110c. LED driver 130 may generate each of signals 150a-150c to be a current pulse wave control form or a voltage pulse wave control form such that the controlled amplitude of the signal represents current or voltage, respectively.

A processor 160 may be provided to control one or more aspects related to driving LEDs 110a-110c and/or detecting a brightness of LEDs 110a-110c. For example, processor 160 may transmit signals to LED driver 130 to control the modulation of LEDs 110a-110c. Processor 160 may originally generate the signals to be transmitted to LED driver 130, or these signals may be generated outside of processor 160 and transmitted or modified by processor 160. In addition, processor 160 may receive signals from other components that are related to driving LEDs 110a-110c and/or to detecting one or more brightnesses of LEDs 110a-110c. The multiple functions of processor 160 and LED driver 130 may be implemented together or separately, and as part of one or more physical components, as would be appropriate for the desired application. The functions of processor 160 and LED driver 130 may also be implemented in hardware, software, or a combination thereof.

LED driver 130 may have a brightness controller 170 to receive brightness data 180 from processor 160. Brightness data 180 may correspond to the desired overall brightness of the LED during the modulation period. Brightness controller 170 may generate a duty pulse within the modulation period to control the brightness of the LED during the modulation period. For example, brightness controller 170 may receive the modulation period from clock supply 140 to suitably time the duty pulse. The duty pulse may be based on received brightness data 180.

To compensate for the deterioration of the spectral emission from the LED backlight, one or more light detectors may also be provided to detect one or more emission spectra from the LED backlight. These emission spectra may be compared to expected emission spectra to evaluate how the LEDs have deteriorated. After evaluation of the deteriorated state of the LED backlight, the signals provided to the LEDs may be calibrated to approximately compensate for the deterioration.

As shown in FIG. 1, a detector 190 may receive light 120a-120c from LEDs 110a-110c in group 100 and detect an intensity (“brightness”) of the received light. Detector 190 may output a signal 200, such as an electrical signal, that indicates the detected intensity of the light. Detector 190 may detect the intensity of the received light at one or more predefined frequencies, or alternatively over substantially the entire frequency spectrum emitted by LEDs. Detector 190 may include a light-sensing element that incurs a detectable physical change when subjected to a change in light, such as for example one or more of a photodiode, photoelectric transistor, color sensor, and photosensitive resistor. Based on the detectable physical change, detector 190 may output signal 200.

Processor 160 may receive signal 200 from detector 190. In an exemplary embodiment, detector 190 may output analog electrical voltages corresponding to the detected light intensity for each of LEDs 110a-110c, respectively. Examples of analog electrical voltages corresponding to LEDs 110a-110c in FIG. 1 are shown as V₁, V₂, and V₃, respectively. Processor 160 may receive these analog electrical voltages and convert them to digital signals. The digital signals may be evaluated to determine the degree of alteration of light output from one or more of LEDs 110a-110c in relation to an expected light output. For example, the digital signals may indicate that the relative brightnesses of one or more of LEDs 110a-110c have deteriorated since a previous detection cycle. Based on the digital signals, the signals 150a-150c provided to LEDs 110a-110c by LED driver 130 may be calibrated to approximately compensate for the alteration of the light output from LEDs 110a-110c.

LED driver 130 may further include a detection controller 210 to receive detection data 220 from processor 160. Detection controller 210 may indicate whether a particular LED or a particular set of LEDs is to be detected during a modulation period. When detection data 220 indicate that the particular LED or set of LEDs is to be detected during the modulation period, detection controller 210 may generate a detection pulse to turn on the particular LED or set of LEDs within the modulation period outputted by clock supply 140. For example, detection controller 210 may receive the modulation period from clock supply 140 to suitably time the detection pulse. LED driver 130 may also have a driver output 230 to output the duty pulse and the detection pulse to the particular LED or set of LEDs on one of signals 150a-150c within the modulation period.

The emission spectra from LEDs 110a-110c may deteriorate as a function of time and temperature. For examples the emission spectra from LEDs 110a-110c may dim unevenly across the frequency domain. This deterioration may result in displayed images that are dulled or have decreased accuracy of color expression.

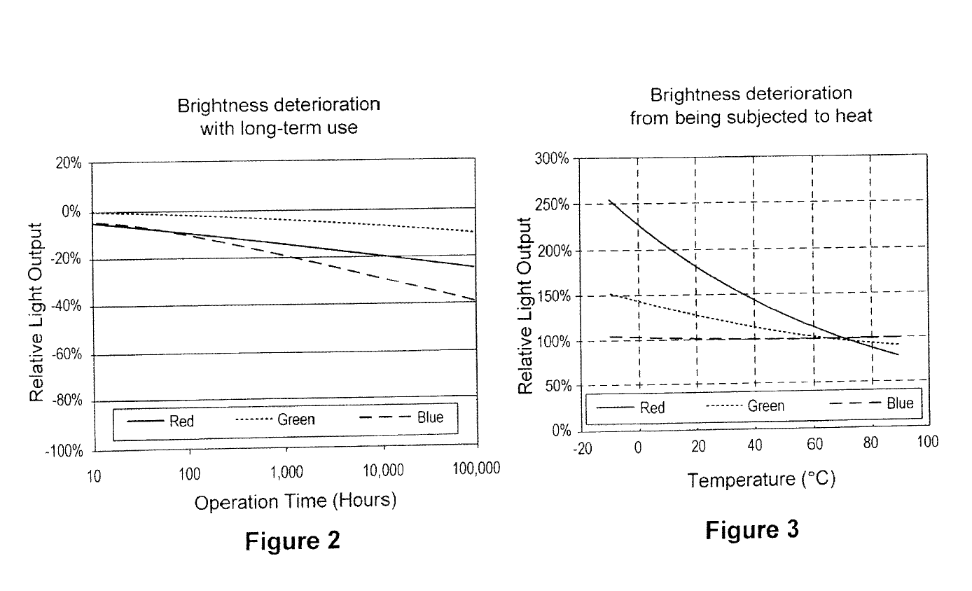

FIG. 2 is a graph showing plots of relative light output for exemplary embodiments of each of a red LED, a green LED, and a blue LED as a function of hours in operation. As shown in the plots, the light outputs of all of the LEDs deteriorate over time. However, the light outputs of the different LEDs also deteriorate at different rates. For example, in the long term, the plots show that the brightness of the blue LED deteriorates more than the brightness of the red LED. The red LED, in turn, deteriorates in brightness in the long term more than the green LED.

FIG. 3 is a graph showing plots of rate of change of relative light output for exemplary embodiments of each of a red LED, a green LED, and a blue LED as a function of a temperature applied to the LEDs. As shown in the plots, the light outputs of all of the LEDs deteriorate with increasing temperature. However, the light outputs of the different LEDs also deteriorate at different rates as the temperature is increased. For example, the plots show that the brightness of the red LED deteriorates more steeply with increasing temperature than the brightness of the green LED. The green LED, in turn, deteriorates in brightness more steeply as temperature is increased than the blue LED.

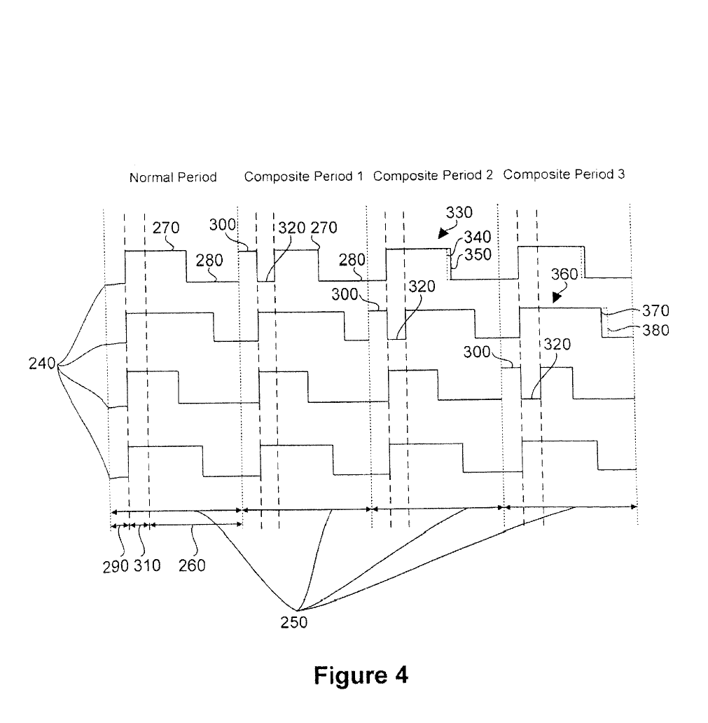

FIG. 4 is a graph showing a plurality of plots, each plot representing an exemplary embodiment of a signal 240 applied to one or more LEDs consistent with the present invention. Signals 240 of FIG. 4 are provided only to illustrate embodiments consistent with the invention, and should not be used to limit the scope of the invention or its equivalents to the exemplary embodiments provided herein. Each of signals 240 includes a plurality of modulation periods 250. Modulation periods 250 may occur within the signal at a predefined frequency, referred to as the frequency of the signal. Within each of modulation periods 250, each signal 240 may include a duty period 260 to control the brightness of the LED based on brightness data 180.

Duty period 260 of signal 240 may include a duty pulse 270 that is applied to the LED to turn on the LED. There may also be a quiescent period 280 of duty period 260 during which LED is placed in a “quiescent” state. During quiescent period 280, duty pulse 270 is not applied to the LED. For example, the LED may be turned off during quiescent period 280. Duty pulse 270 may be arranged before quiescent period 280 in duty period 260 of signal 240. For example, after duty pulse 270, signal 240 may return to the “quiescent” state during quiescent period 280 until the subsequent modulation period of signal 240.

The brightness of an LED may be modulated by pulse-width modulation (PWM), such as shown in FIG. 4, and modulation periods 250 may be referred to as “PWM cycles.” Within each of modulation periods 250, the signal may be “high” for the duration of duty pulse 270. The signal may be “low” for the remainder of duty pulse 270 within duty period 260. Increasing the duration (“width”) of duty pulse 270 may increase the resulting brightness of the LED that receives the signal, and decreasing the duration of duty pulse 270 may decrease the resulting brightness.

An LED may be turned on during a detection period 290, while other LEDs are turned off during detection period 290, to detect an actual brightness level of the LED that is turned on concurrent with detection period 290. For example, an individual LED or a plurality of LEDs may be turned on by applying a detection pulse 300 to the individual LED or plurality of LEDs during detection period 290. Meanwhile, detection pulses 300 may not be applied to remaining LEDs, which are not being detected. Those remaining LEDs may be turned off during detection period 290. A periodic sequence of such detection periods 290 for the individual LEDs or sets of LEDs may be defined. LED driver 130 may turn on and off the LEDs using detection pulses 300 according to the detection sequence such that all of the individual LEDs or sets of LEDs can be detected over the course of the detection sequence.

Detection pulse 300 enables detection of the emission of the LED being detected substantially without interference from the LEDs that are not being detected. In FIG. 4, the multiple occurrences of detection pulses 300 are labeled. For example, a signal may have a “high” value (such as a nonzero value) during detection period 290 when detection pulse 300 is applied, and a “low” value (such as a value of substantially zero) when detection pulse 300 is not applied. Detection pulse 300 enables concurrent detection of light emission from the LED to which detection pulse 300 is being applied.

During a modulation period that is labeled as a “Normal Period” in FIG. 4, all of the LEDs are turned off during the detection period. For example, all of the LEDs may be used solely to emit light based on the brightness data received by the LED driver 130. During the modulation periods that are labeled as “Composite Periods” in FIG. 4, at least one of the LEDs is turned on during detection period 290 and may subsequently also be turned on during duty period 260 to emit light based on the brightness data. For example, one LED may be turned on during the detection period to enable the detector to detect its actual brightness, and the same LED may subsequently also be turned on during duty period 260 to emit light based on the brightness data. Meanwhile, all of the remaining LEDs may be turned off during the detection period. These remaining LEDs may subsequently also be turned on during duty period 260 to emit light based on the brightness data.

Detection period 290 may be adapted to enable detection of the actual brightness level of the LED receiving the corresponding signal, without affecting an average brightness of the LED during modulation period 250 to a substantially unnecessary degree. For example, the detector used to detect the actual brightness level of the LED may have a response time that is a minimum time during which the LED should be turned-on to enable the detector to make an accurate detection. Detection period 290 may have a duration that is at least equal to, and not substantially greater than, this response time. For example, detection period 290 may be selected to be approximately equal to the response time of the detector.

In another exemplary embodiment, the light detector may simultaneously detect a brightness of a plurality of LEDs. For example, the LEDs may be LEDs of a particular color or LEDs within a particular spatial region. In each modulation cycle, a brightness of a different plurality of LEDs may be detected. For example, in subsequent modulation cycles, the brightness of LEDs of different colors or LEDs in different regions may be detected.

Detecting the LED brightnesses on an individual basis may permit more accurate evaluation of the brightnesses of the individual LEDs than detecting the LED brightnesses on a collective basis. For example, if the brightnesses of the LEDs are compensated based on a collective brightness measurement, relative bright and dark spots may develop across the LED array. These spots may also “drift” across the LED array relative to one another. For example, if a brightness of all LEDs of a particular color is measured collectively, colors may separate across the LED array and these colors may drift relative to one another.

However, detecting the LED brightnesses on a collective basis may permit faster evaluation and compensation than detecting the LED brightnesses on an individual basis. For example, the time required for evaluation of the LED brightnesses may be approximately inversely proportional to the number of individual LEDs that are grouped to have a brightness of the group detected collectively.

Application of signals 240 having detection periods 290 may permit detection of the brightnesses of the one or more LEDs receiving detection pulses 300 while substantially preventing interference by other LEDs in the detection process. Furthermore, by incorporating detection period 290 within modulation period 250 of a signal, detection of the LED brightnesses may be performed without substantially disrupting the frequency of the signal. The frequency of the signal applied to one LED may also match the frequencies of the signals applied to one or more of the other LEDs, such as shown in FIG. 4.

In addition to detection period 290, modulation period 250 may also include a compensation period 310 to compensate the light output from the LED for the value of signal 240 during detection period 290. Compensation period 310 may be arranged after detection period 290 and before duty period 260. However, compensation period 310 may alternatively or additionally be arranged somewhere else within modulation period 250. For example, compensation period 310 may be arranged before detection period 290 or after duty period 260.

The value of signal 240 during compensation period 310 and the duration (“width”) of compensation period 310 may be adapted to compensate for human perception of the brightnesses from the LEDs resulting from detection period 290. When signal 240 is applied to the LED, the value of signal 240 during detection period 290 produces a primary effect on the average brightness of the LED during modulation period 250. Signal 240 may be generated to have a value during compensation period 310 that produces a substantially opposite secondary effect on the brightness of the LED within the same modulation period.

In an exemplary embodiment, when detection pulse 300 is not applied during detection period 290, then a compensation pulse 320 may be applied during compensation period 310 to compensate for the lack of brightness produced by the absence of detection pulse 300. Conversely, when detection pulse 300 is applied during detection period 290, then a compensation pulse 320 may not be applied during compensation period 310 to compensate for the brightness produced by the detection pulse 300.

Furthermore, the width of compensation period 310 may be selected to compensate for detection period 290. In an exemplary embodiment, compensation period 310 may be adapted to have a width of from about 95% to about 105% of a width of detection period 290 to suitably compensate for human perception of the brightnesses from the LEDs resulting from detection period 290. For example, the width of compensation period 310 may be selected to be substantially the same as the width of detection period 290.

The value of signal 240 during compensation period 310 may compensate for the value of signal 240 during detection period 290 to avoid a substantial effect on the average brightness of the LEDs being detected during modulation period 250. By arranging compensation period 310 within modulation period 250, an undesirable effect on brightness of the LEDs over time may be limited. For example, brightness changes that could otherwise be perceived by human vision as visual artifacts, such as flickering or noise, may be mitigated. The visual artifacts that may otherwise present themselves may be perceived consciously or subconsciously, and may result in a perceived lack of quality of the image being displayed, eye pain or headaches for the human viewing the display, or other undesirable effects Thus, the detection pulse and compensation pulse may be adapted to substantially prevent an undesirable perception of the brightness-detection process by a human viewer of a display that incorporates the LED backlight.

Based on the detected brightness levels of the LEDs, the signals provided to the LEDs may be calibrated to approximately make up for the alteration of the brightness levels from the LEDs. For example, processor 160 may generate correction data that indicates how the signals provided to the LEDs should be calibrated to achieve the desired brightness levels. The processor may transmit the correction data to LED driver 130, where it may be stored. When LED driver 130 generates the duty pulses of the signals that drive the LEDs, LED driver 130 may calibrate the duty pulses based on the stored correction data.

For example, FIG. 4 shows a duty pulse 330 in one of the modulation periods 250. In this embodiment, duty pulse 330 would have an uncalibrated duration 340 without any feedback from detector 190 and processor 160. However, processor 160 calibrates duty pulse 330 to have a calibrated duration 350 that is different from uncalibrated duration 340. In this example, duty pulse 330 is lengthened to increase brightness. As shown in FIG. 4, the duty pulse in the subsequent modulation period may have a similarly calibrated duration absent any further feedback from detector 190 and processor 160 in the interim time span. Processor 160 may also calibrate another duty pulse 360 to have a calibrated duration 370 that is different from an uncalibrated duration 380. In this example, duty pulse 360 is shortened to decrease brightness.

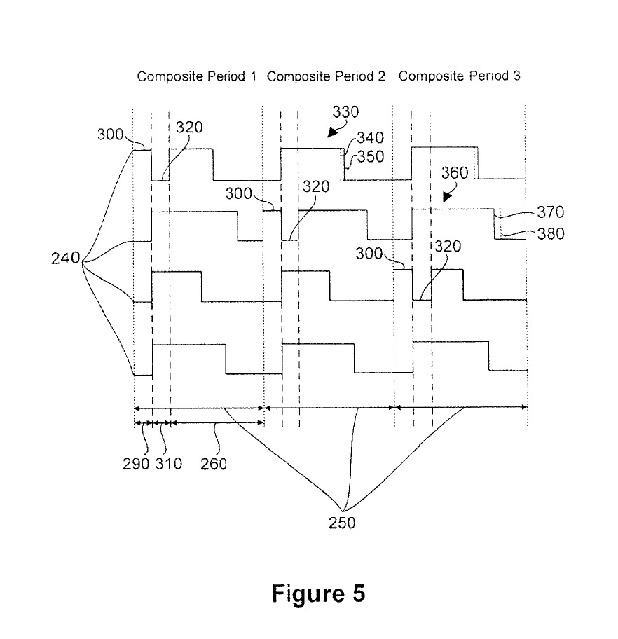

FIG. 5 is a graph showing a plurality of plots, each plot representing an exemplary embodiment of a signal applied to one or more LEDs consistent with the present invention. Unlike the signals shown in FIG. 4, the modulation period labeled as “Normal Period” is absent from the signals shown in FIG. 5. In the embodiment shown in FIG. 5, detection pulse 300 is continuously being applied to at least one of the LEDs to enable detection of those LEDs. Meanwhile, all of the LEDs can be turned on during duty periods 260 to achieve brightnesses that correspond to the brightness data.

Although embodiments consistent with the present invention have been described in considerable detail with regard to embodiments thereof, other versions are possible. For example, the LED backlight may comprise other LEDs or arrangements of LEDs equivalent in function to the illustrative structures herein. Furthermore, the LED driver may include an individual LED driver or a plurality of LED drivers. Relative or positional terms, such as “one,” “two,” and “three,” are used with respect to the exemplary embodiments and are interchangeable. Therefore, the appended claims should not be limited to the description of the versions contained herein.

What is claimed is:

1. An LED driver to drive an LED, the LED driver comprising:
a clock supply to periodically output a modulation period;
a brightness controller to
receive brightness data corresponding to the desired brightness of the LED, and
generate a pulse-width-modulated (PWM) duty pulse within the modulation period, a width of the PWM duty pulse being based on the brightness data;
a detection controller to
receive detection data indicating whether the LED is to be detected during the modulation period, and
when the detection data indicate that the LED is to be detected during the modulation period, generate a detection pulse within the modulation period; and
a driver output to output the PWM duty pulse and the detection pulse to the LED within the modulation period.

2. An LED driver according to claim 1, wherein the detection controller is adapted to generate the detection pulse to be arranged before the PWM duty pulse within the modulation period.

3. An LED driver according to claim 1, wherein the detection controller is adapted to further generate a compensation period, within the modulation period, to compensate for the detection pulse in the brightness of the LED.

4. An LED driver according to claim 3, wherein the detection controller is adapted to generate the compensation period to be arranged after the detection pulse and before the PWM duty pulse within the modulation period.

5. An LED driver according to claim 3, wherein the detection controller is adapted to generate the compensation period to have a width of from about 95% to about 105% of a width of the detection pulse.

6. An LED driver according to claim 1 wherein the detection controller is adapted to, when the detection data indicate that the LED is not to be detected during the modulation period, generate both a detection period and a compensation pulse within the modulation period, the detection period being absent a detection pulse.

7. An LED driver according to claim 1, wherein the LED comprises a red LED, a green LED, or a blue LED.

8. An LED driver according to claim 1, wherein the LED comprises a white LED.

9. An LED driver according to claim 1 to drive a plurality of LEDs,
wherein the brightness controller is adapted to, for each of a plurality of LEDs,
receive brightness data corresponding to a desired brightness of the LED, and
generate a pulse-width-modulated (PWM) duty pulse within the modulation period, a width of the PWM duty pulse being based on the brightness data;
wherein the detection controller is adapted to
receive detection data indicating whether at least one of the LEDs is to be detected during the modulation period, and
when the detection data indicate that the at least one LED is to be detected during the modulation period, generate a detection pulse within the modulation period; and
wherein the driver output is adapted to output the PWM duty pulse to the plurality of LEDs within the modulation period, and to output the detection pulse to the at least one LED within the modulation period.

10. An LED backlight for a liquid-crystal display, the LED backlight comprising:
an array of LEDs to illuminate a panel of controllably transmissive elements of a liquid-crystal display; and
one or more LED drivers according to claim 1 to drive the array of LEDs.

11. A method of driving an LED, the method comprising:
periodically outputting a modulation period;
receiving brightness data corresponding to the desired brightness of the LED;
generating a pulse-width-modulated (PWM) duty pulse within the modulation period, a width of the PWM duty pulse being based on the brightness data;
receiving detection data indicating whether the LED is to be detected during the modulation period;
when the detection data indicate that the LED is to be detected during the modulation period, generating a detection pulse within the modulation period; and
outputting the PWM duty pulse and the detection pulse to the LED within the modulation period.

12. A method according to claim 11, wherein generating the detection pulse comprises generating the detection pulse to be arranged before the PWM duty pulse within the modulation period.

13. A method according to claim 11, further comprising generating a compensation period, within the modulation period, to compensate for the detection pulse in the brightness of the LED.

14. A method according to claim 13, wherein generating the compensation period comprises generating the compensation period to be arranged after the detection pulse and before the PWM duty pulse within the modulation period.

15. A method according to claim 13, wherein generating the compensation period comprises generating the compensation period to have a width of from about 95% to about 105% of a width of the detection pulse.

16. A method according to claim 11, wherein, when the detection data indicate that the LED is not to be detected during the modulation period, generating both a detection period and a compensation pulse within the modulation period, the detection period being absent a detection pulse.

17. A method according to claim 11, wherein driving the LED comprises driving a red LED, a green LED, or a blue LED.

18. A method according to claim 11, wherein driving the LED comprises driving a white LED.

19. A method according to claim 11 of driving a plurality of LEDs, the method comprising
for each of a plurality of LEDs,
receiving brightness data corresponding to a desired brightness of the LED, and
generating a pulse-width-modulated (PWM) duty pulse within the modulation period, a width of the PWM duty pulse being based on the brightness data;
receiving detection data indicating whether at least one of the LEDs is to be detected during the modulation period;
when the detection data indicate that the at least one LED is to be detected during the modulation period generating a detection pulse within the modulation period; and
outputting the PWM duty pulse to the plurality of LEDs within the modulation period, and outputting the detection pulse to the at least one LED within the modulation period.

20. A method of backlighting a liquid-crystal display, the method comprising:
providing an array of LEDs to illuminate a panel of controllably transmissive elements of a liquid-crystal display; and
driving the LEDs of the array by a method according to claim 11.
